(19) United States
(12) Patent Application Publication
(10) Pub. No.: US 2008/0268697 A1
(43) Pub. Date: Oct. 30, 2008

(54) Wire comb holder, particularly for electrical wiring apparatuses

(75) Inventor: Vladimiro Carlotto, Zagarolo (IT)

Correspondence Address: MODIANO & ASSOCIATI, Via Meravigli, 16, MILANO, 20123, IT

(73) Assignee: K.M.I. TRADE S.R.L.

(21) Appl. No.: 12/081,728

(22) Filed: Apr. 21, 2008

(30) Foreign Application Priority Data
Apr. 26, 2007 (IT) PD2007A000153

(51) Int. Cl. H01R 4/24

(52) U.S. Cl. 439/438

(57) ABSTRACT

A wire comb holder, particularly for electrical wiring apparatuses, which allows to process wires of different cross-section or diameter, comprising two series of forks which are arranged side by side and can be divaricated elastically, the series of forks facing each other in a parallel arrangement and being spaced so that each fork of a first series is matched symmetrically by a fork of the second facing series; each of the forks protrudes, substantially at right angles, from a common base and has its ends arranged closer and contoured so as to form a recess which is open at the opposite end with respect to the base, for a wire to be handled.

The present invention relates to a wire comb holder particularly for electrical wiring apparatuses.

### BACKGROUND OF THE INVENTION

Apparatuses for providing electrical wirings are currently known; such wirings can be for example of the type constituted by electric wires inserted in corresponding receptacles of a connector provided with corresponding electrical terminals to which the wires are connected, or can be complete wirings, i.e., constituted by pairs of connectors interconnected by wires.

A similar apparatus is disclosed in US-2007-0082558 and EP1775804 in the name of this same applicant; such apparatus generally comprises a region for loading wires to be wired on corresponding preset seats selected among a plurality of seats formed on a comb holder, which is moved from such loading region to a region for inserting the wires in preset receptacles formed in one or more prearranged connectors to be wired.

In this region for the insertion of the wires in the connector (or connectors) there are means for the guided translational motion of the ends of the wires within the preset receptacles of the connectors.

The apparatus also comprises programmable electronic means, such as for example a PLC (Programmable Logic Controller, an industrial computer specialized in the management of industrial processes) or a dedicated personal computer, which are adapted to match up, in such insertion region, the prearranged seats of the comb holder in which corresponding wires are present with the prearranged receptacles of the connectors.

In particular, in the loading region there is a grip and insertion assembly which is adapted to engage a wire and insert it within the prearranged seat selected among the plurality of seats formed on the comb holder.

Such grip and insertion assembly, which comprises clamps for centering and locking the wire and for insertion in the prearranged seat on the comb holder, is managed by such programmable electronic means to perform an automated loading of the comb holder according to a programmed sequence of preferred positions which correspond to a matching number of prearranged receptacles of the connector.

The comb holder is constituted by two walls, which face each other in a parallel arrangement at certain distance from each other and on each of which there is a series of U-shaped recesses, which provide the seats for accommodating from above a corresponding wire.

Each U-shaped recess of a first wall is matched symmetrically by a U-shaped recess of the second facing wall; the two walls of forks rise upward from a common base.

One drawback of apparatuses provided with such a comb holder is that they can handle only wires which have such a diameter that they can be inserted by the grip and insertion assembly with limited force in the U-shaped recesses, such dimensions also ensuring the retention of the wires in such U-shaped recesses.

In case of preparation of the apparatus to handle wires having a different diameter, it is necessary to replace the comb holder with another one which is structurally similar but has U-shaped recesses which have different dimensions and are useful for handling wires of a corresponding diameter.

This replacement entails not only halting the operation of the apparatus and using labor to perform such replacement but also the need for the manufacturer to have as many different comb holders as there are wires of different diameter.

### SUMMARY OF THE INVENTION

The aim of the present invention is to provide a wire comb holder particularly for electrical wiring apparatuses which is capable of obviating the drawbacks shown by known types of holder.

Within this aim, an object of the present invention is to provide a wire comb holder which can be adapted to handle wires having a different cross-section.

Another object of the present invention is to provide a wire comb holder which can also be installed in wiring apparatuses of a known type which are in use.

Another object of the present invention is to provide a wire comb holder particularly for electrical wiring apparatuses which can be manufactured cheaply with known equipment and technologies.

This aim and these and other objects, which will become better apparent hereinafter, are achieved by a wire comb holder, particularly for electrical wiring apparatuses, characterized in that it is constituted by two series of forks which are arranged side by side and can be divaricated elastically, said series of forks facing each other in a parallel arrangement and being spaced so that each fork of a first series is matched symmetrically by a fork of the second facing series, each of said forks protruding from a common base and having its ends arranged closer and contoured so as to form a recess which is open at the opposite end with respect to the base for a wire to be handled.

### BRIEF DESCRIPTION OF THE DRAWINGS

Further characteristics and advantages of the invention will become better apparent from the following detailed description of a preferred but not exclusive embodiment thereof, illustrated by way of non-limiting example in the accompanying drawings, wherein:

FIG. 1 is a schematic view of a wiring apparatus provided with a wire comb holder according to the invention;

FIG. 2 is a perspective view of the holder according to the invention;

FIG. 3 is a front view of a detail of the holder according to the invention.

### DESCRIPTION OF THE PREFERRED EMBODIMENTS

With reference to the figures, a wire comb holder particularly for electrical wiring apparatuses according to the invention, is generally designated by the reference numeral 10.

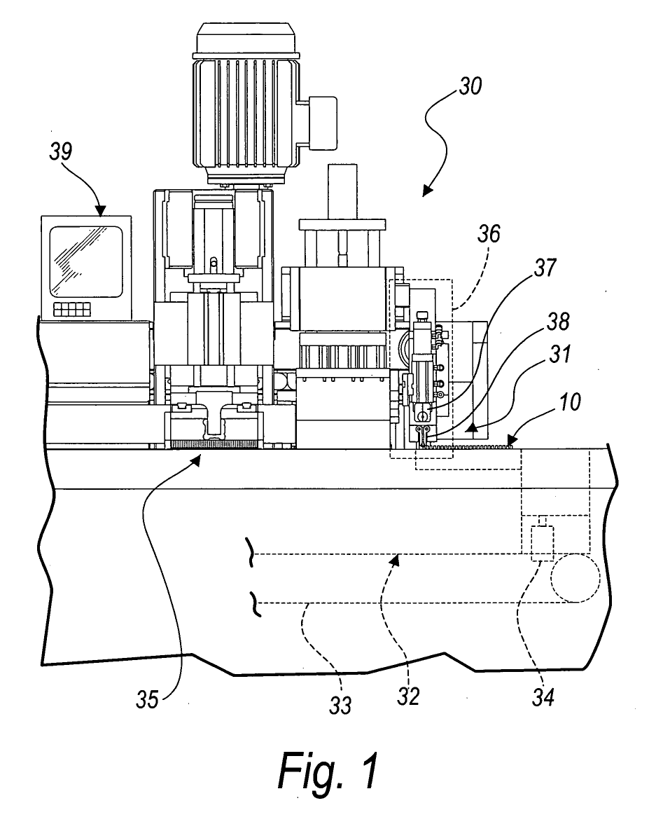

The comb holder 10 is shown in FIG. 1 installed on a wiring apparatus 30; the apparatus 30 comprises, by way of example, a wire loading region 31, where the holder 10 according to the invention is arranged initially, and movement means 32 for transferring the holder 10 from the loading region 31 to a cable insertion region 35, said movement means being constituted for example by a conveyor belt 33 for the horizontal translational motion and by an actuator 34 for the vertical translational motion of the holder 10; broken lines 36 further designate the assembly for gripping and inserting the wires on the comb holder 10, a wire centering clamp 37 and a locking and insertion clamp 38 of said assembly being highlighted.

The apparatus 10 is managed in its operation by programmable electronic means 39, of a per se known type, such as for example a PLC or a dedicated personal computer.

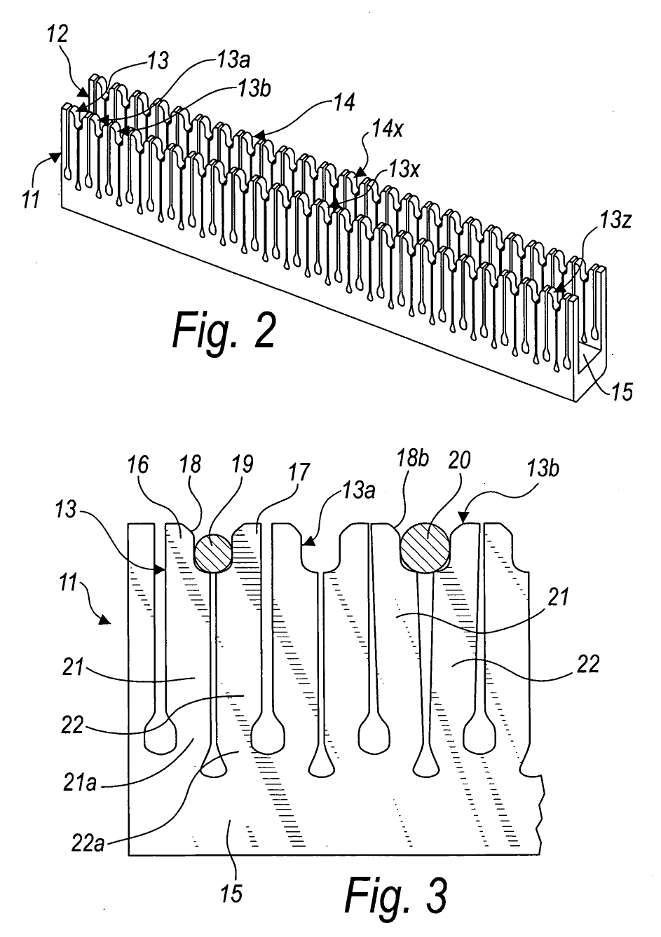

The wire comb holder 10 according to the invention is shown in detail in FIGS. 2 and 3.

The holder 10 is constituted by two series, respectively 11 and 12, of forks arranged side by side, some of which are designated by the reference numerals 13, 13a, 13b, 13x, 13z, 14 and 14x.

The forks 13, 14, et cetera, can be divaricated elastically.

The two series of forks 11 and 12 face each other in a parallel arrangement and are mutually spaced so that each generic fork 13x of the first series 11 is matched symmetrically by a fork 14x of the second facing series 12.

Each one of said forks protrudes substantially at right angles from a common base 15.

Each fork 13, 14 et cetera has its free ends 16 and 17 arranged close to each other and contoured so as to form a recess 18 which is open at an end that is opposite with respect to the base 15, upward in the embodiment as shown in the figures, for allowing insertion of a cable to be handled; FIG. 3 illustrates a first wire 19, which has a first diameter, and a second wire 20 having a second diameter, which is larger than the diameter of the first wire 19.

The ends 16 and 17 of each fork 13, 14 et cetera are contoured so that the wire insertion recess 18 is substantially U-shaped.

Each elastically divaricable fork 13, 13a, 13b, 13x, 13z, 14, 14x is constituted by two bars, a first bar 21 and a second bar 22.

Each one of the bars 21 and 22 is connected to the base 15 by a portion 21a and 22a respectively, which has a narrower cross-section and is flexible and allows their reversible divarication; the portion 21a and 22a has a cross-section which is indeed narrower than the body of the bar 21 and 22.

The bars 21 and 22 that form the forks 13, 14 et cetera protrude monolithically from the base 15.

In practice it has been found that the invention thus described achieves the intended aim and objects.

In particular, the present invention provides a wire comb holder particularly for electrical wiring apparatuses which can be adapted to handle wires of different cross-sections, as shown by way of example in FIG. 3.

Said figure in fact shows that the fork 13 accommodates in the recess 18 the first wire 19 which has a certain cross-section and that the second wire 20 having a cross-section with a larger diameter is instead inserted in the third fork 13b.

The bars 21 and 22 of the fork 13b are divaricated elastically by the wire 20 which, being pushed into the recess 18b, enters it by way of the bevels of the ends 16 and 17, moving apart the two contoured ends 16 and 17 that form it; the bars 21 and 22, thanks to of the elastic bridges 21a and 22a, tend to return to their original position, pressing on the wire and retaining it in the recess 18 and 18b.

Further, by means of the invention a wire comb holder has been devised which can also be installed in wiring apparatuses of a known type which are in use.

Moreover, the present invention has provided a wire comb holder particularly for electrical wiring apparatuses which can be manufactured cheaply with known equipment and technologies and for example by molding plastic material.

The invention thus conceived is susceptible of numerous modifications and variations, all of which are within the scope of the appended claims; all the details may further be replaced with other technically equivalent elements.

In practice, the materials employed, so long as they are compatible with the specific use, as well as the dimensions, may be any according to requirements and to the state of the art.

The disclosures in Italian Patent Application No. PD2007A000153 from which this application claims priority are incorporated herein by reference.

What is claimed is:

1. A wire comb holder for electrical wiring apparatuses, comprising two series of elastically divaricatable forks arranged side by side, said series of forks being located so as to face each other in a parallel arrangement and being spaced so that each fork of a first one of said series is matched symmetrically by a fork of a second one of said series, and wherein each of said forks protrudes from a common base thereof and has free ends arranged close to each other and contoured so as to form a recess, said recess being open so that a wire to be handled is insertable between said free ends and in the recess.

2. The holder of claim 1, wherein each elastically divaricable fork is constituted by two bars, each of which is connected to said base by way of a portion having a narrow cross-section which is flexible and allows reversible divarication thereof.

3. The holder of claim 1, wherein said free ends of each fork are contoured so that said recess for wire insertion is substantially U-shaped.

4. The holder of claim 2, wherein said bars that form each one of said forks are formed monolithically with and protrude from said base.
